(19) United States
(12) Patent Application Publication
(10) Pub. No.: US 2025/0337062 A1
(43) Pub. Date: Oct. 30, 2025

(54) SECONDARY BATTERY AND METHOD FOR MANUFACTURING THE SAME

(71) Applicant: Samsung SDI Co., Ltd., Yongin-si (KR)

(72) Inventor: Jea Woan Lee, Yongin-si (KR)

(73) Assignee: Samsung SDI Co., Ltd., Yongin-si (KR)

(21) Appl. No.: 18/946,241

(22) Filed: Nov. 13, 2024

(30) Foreign Application Priority Data
Apr. 30, 2024 (KR) 10-2024-0057315

(51) Int. Cl. H01M 50/169; H01M 50/103; H01M 50/15

(52) U.S. Cl. CPC H01M 50/169; H01M 50/103; H01M 50/15

(57) ABSTRACT

Embodiments relate to a secondary battery, in which an unnecessary space in a case is reduced to increase energy density, and a method for manufacturing the same. A secondary battery includes an electrode assembly provided with a first electrode plate and a second electrode plate, and a case accommodating the electrode assembly. The case includes a first case having a recess, in which the electrode assembly is accommodated, at a central area thereof, wherein the first case has one surface opened, and a second case configured to seal the one opened surface of the first case. The first case further includes an extension part extending from one end of the recess and coupled to the second case, and a round part between the recess and the extension part. A curvature radius of the round part is equal to or greater than a thickness of the first case.

### CROSS-REFERENCE TO RELATED APPLICATIONS

This present application claims priority to and the benefit under 35 U.S.C. § 119(a)-(d) of Korean Patent Application No. 10-2024-0057315, filed on Apr. 30, 2024, in the Korean Intellectual Property Office, the entire disclosure of which is incorporated herein by reference.

### FIELD

Embodiments relate to a secondary battery and a method for manufacturing the same.

### BACKGROUND

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery, in which an unnecessary space in a case is reduced to provide an increase in energy density, and a method for manufacturing the same.

These and other aspects and features of the present disclosure will be described in or will be apparent from the following description of embodiments of the present disclosure.

According to some embodiments, a secondary battery includes: an electrode assembly provided with a first electrode plate and a second electrode plate; and a case in which the electrode assembly is accommodated, wherein the case includes: a first case having a recess, in which the electrode assembly is accommodated, at a central area thereof, wherein the first case has one opened surface; and a second case configured to seal the one opened surface of the first case, wherein the first case further includes: an extension part extending from one end of the recess and coupled to the second case; and a round part between the recess and the extension part, wherein a curvature radius of the round part is equal to or greater than a thickness of the first case.

The curvature radius of the round part may be approximately 100% to approximately 500% of the thickness of the first case.

The second case may be a flat plate.

The extension part may be parallel to the second case.

The case may further include a coupling part coupling, by welding, the extension part of the first case to an edge of the second case.

The coupling part may be provided by laser welding in a direction of the extension part of the first case from an outer surface of the second case and may be adjacent to the recess.

The first case and the second case may be sealed by the coupling part.

The coupling part may be disposed at a boundary between the extension part of the first case and the round part.

Each of the first case and the second case may be made of steel, stainless steel, nickel-plated steel, or a steel alloy.

The recess may have a rectangular parallelepiped shape with one surface opened, and the extension part may be bent to have a round part from four sides of one end of the recess so as to extend in a first direction parallel to the second case and a second direction.

Each of the first case and the second case may have a thickness of approximately 0.05 mm to approximately 0.4 mm.

In some embodiments, a method for manufacturing a secondary battery includes: welding a first case having a recess, in which an electrode assembly is accommodated, and an extension part extending to be bent outward from one end of the recess to a second case having a plate shape parallel to the first case to provide a coupling part through which the first case and the second case are coupled to each other by welding; and removing an area, except for an area on which the coupling part secures sealability (of the first case and the second case), on the extension part of the first case and an edge area of the second case.

The recess may have a rectangular parallelepiped shape with one surface opened, and the extension part may be bent to have a round part from four sides of one end of the recess so as to extend in a first direction parallel to the second case and a second direction, wherein a curvature radius of the round part may be equal to or greater than a thickness of the first case.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of a secondary battery according to some embodiments;

FIG. 2 illustrates a cross-sectional view taken along lie 2-2′ of the secondary battery of FIG. 1;

FIG. 3 illustrates a cross-sectional view taken along lie 3-3′ of the secondary battery of FIG. 1;

FIG. 4 illustrates an exploded perspective view of a case in the secondary battery of FIG. 1;

FIG. 5 illustrates an enlarged view of a portion 5 of FIG. 3;

FIG. 6 illustrates a schematic view of a smartphone on which the secondary battery of FIG. 5 is mounted according to some embodiments;

FIGS. 7A and 7B illustrate a perspective view of a battery pack including the secondary battery according to some embodiments; and

FIGS. 8A and 8B illustrate perspective and side views of a vehicle including an exemplary battery pack according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “approximately,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

However, the aspects and features of the present disclosure are not limited to those described above, and other aspects and features not expressly described herein will be clearly understood by a person skilled in the art from the description of example embodiments of the present disclosure described below.

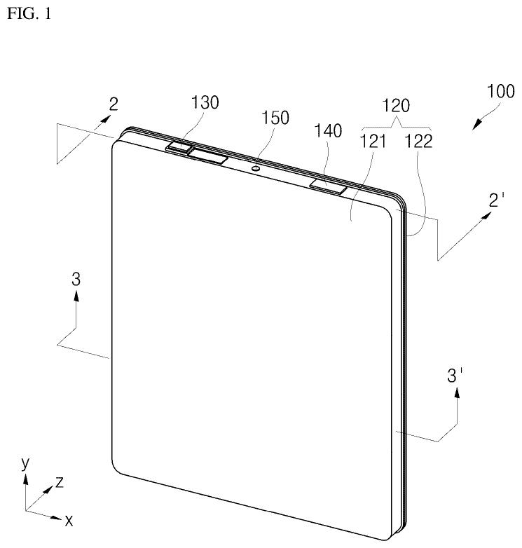

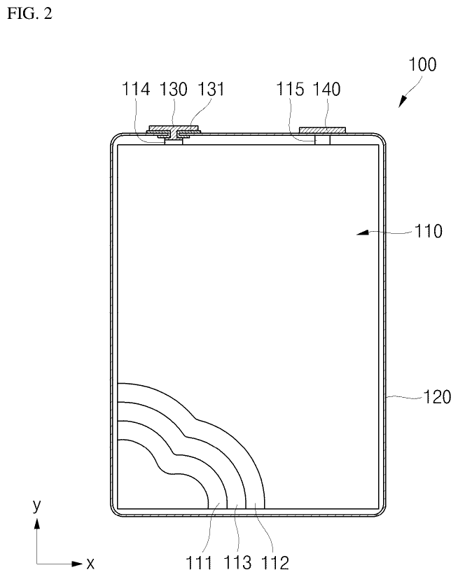

FIG. 1 illustrates a perspective view of a secondary battery 100 according to some embodiments. FIG. 2 illustrates a cross-sectional view of the secondary battery 100 according to some embodiments. FIG. 2 illustrates a cross-sectional view taken along lie 2-2′ of FIG. 1. As illustrated in FIGS. 1 and 2, the secondary battery 100, according to some embodiments, may include an electrode assembly 110 and a case 120 that accommodates the electrode assembly 110.

The case 120 may include a first case 121 having an approximately rectangular shape with one surface opened and a second case 122 coupled to the opened surface of the first case 121. The case 120 may provide an outer appearance of the secondary battery 100. The case 120 may include or be referred to as a can, a housing, or an exterior. The first case 121 and the second case 122 may include steel, stainless steel, nickel-plated steel, or a steel alloy. Because each of the first case 121 and the second case 122 may include steel, the first case 121 and the second case 122 may have corrosion resistance and an increase in rigidity. The first case 121 may have a top surface, a bottom surface, and two short side surfaces, which extend from four sides of one front long side surface having a rectangular shape in a third direction z that is a direction toward a rear surface. The top surface, the bottom surface, and the two short side surfaces of the first case 121 may have the same width. The second case 122 may be coupled to an opened rear surface of the first case 121 to complete the case 120, which has an approximately hexahedral shape. A space may be provided inside the first case 121 by drawing. The second case 122 may have an approximately flat plate shape and/or may be a flat plate. In some embodiments, the first case 121 and the second case 122 may be sealed and coupled by welding (e.g., the second case may seal an opened surface of the first case). The case 120 may have a shape that surrounds the electrode assembly 110, and the shape of the case 120 may be changed in various manners depending on the shape of the electrode assembly 110.

The electrode assembly 110 may be accommodated inside the case 120 together with an electrolyte (optionally). The electrode assembly 110 may include or be referred to as an electrode group, an electrode body, a stack, or a wound jelly roll. The electrode assembly 110 may include a first electrode plate 111, a second electrode plate 112, and a separator 113 between the first electrode plate 111 and the second electrode plate 112. The electrode assembly 110 may be implemented with various modifications, such as being stacked in a plate shape or rolled in a jelly roll shape. The electrode assembly 110 may be alternately stacked in order of the first electrode plate 111, the separator 113, the second electrode plate 112, and the separator 113. The separator 113 or the second electrode plate 112 may be disposed at the outermost side of the electrode assembly 110, and the case 120 and the first electrode plate 111 may be electrically separated from each other.

The first electrode plate 111 may include a first base material and a first active material layer provided on one surface or both surfaces of the first base material. A first electrode tab 114 that is a first non-coated portion, on which the first active material layer is not disposed, of the first base material may extend outward from the first electrode plate 111. The first electrode tab 114 may be formed by punching the first electrode non-coated portion of the first electrode plate 111 or formed by coupling a separate tab configuration to the first electrode non-coated portion. The first electrode tab 114 may be electrically connected to a first terminal 130, which will be described later.

The second electrode plate 112 may include a second base material and a second active material layer provided on one surface or both surfaces of the second base material. A second electrode tab 115 that is a second non-coated portion, on which the second active material layer is not disposed, of the second base material may extend outward from the second electrode plate 112. The second electrode tab 115 may be formed by punching the second electrode non-coated portion of the second electrode plate 112 or formed by coupling a separate tab configuration to the second electrode non-coated portion. The second electrode tab 115 may be electrically connected to the second terminal 140. In some embodiments, the first electrode tab 114 and the second electrode tab 115 may extend in a second direction y, which is a height direction of the electrode assembly.

The first electrode tab 114 and the second electrode tab 115 may extend and protrude outward from one surface of the electrode assembly 110. In some embodiments, the one surface of the electrode assembly 110 may be a top surface. The first electrode tab 114 and the second electrode tab 115 may be spaced apart from each other on the top surface of the electrode assembly 110 in the first direction x, which is a longitudinal direction of the top surface. For another example, the first electrode tab 114 and the second electrode tab 115 may be separate lead tabs that are in contact with and coupled to the first non-coated portion and the second non-coated portion of the electrode assembly 110, respectively.

The first electrode plate 111 may function as a positive electrode. In some embodiments, the first base material may be provided as, for example, aluminum foil, and the first active material layer may include, for example, transition metal oxide. The second electrode plate 112 may function as a negative electrode. In some embodiments, the second base material may be provided as, for example, copper foil or nickel foil, and the second active material layer may include, for example, graphite. The separator 113 may function to prevent short circuit between the first and second electrodes 111 and 112 from occurring while allowing movement of lithium ions. The separator 113 may be provided as, for example, a polyethylene film, a polypropylene film, a polyethylene-polypropylene film, etc.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8,0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d<0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material. The current collector can be a metal foil.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The secondary battery 100 may further include a first terminal 130 and a second terminal 140, which are provided on the top surface of the case 120. The first terminal 130 may be electrically insulated from the case 120 and may be in contact with and electrically connected to the first electrode tab 114 of the electrode assembly 110. The first electrode tab 114 of the electrode assembly 110 may be disposed between the first terminal 130 and the top surface of the electrode assembly 110.

An insulating member 131 may be disposed between the first terminal 130 and the case 120. The first terminal 130 may pass through the case 120 so that an upper portion of the first terminal 130 is exposed and protrudes to the outside of the case 120. The first terminal 130 may pass through the case 120 so that a lower portion of the first terminal 130 is disposed inside the case 120, and the first electrode tab 114 of the electrode assembly 110 may be in contact with and coupled to a lower end of the first terminal 130 by welding. In some embodiments, the insulating member 131 may include or be referred to as a gasket. The insulating member 131 may be illustrated as being integrated or one piece, but may be constituted by an insulating member that is in contact with an outer surface of the case 120, an insulating member that is in contact with an inner surface of the case 120, and a gasket disposed in a terminal hole of the case 120. However, the insulating member is not limited thereto.

The second terminal 140 may be in contact with and electrically connected to the case 120. The second terminal 140 may be a partial area of the case 120. The second terminal 140 may be electrically connected to the second electrode tab 115 of the electrode assembly 110. For example, the second electrode tab 115 may be in contact with and electrically connected to the case 120. The second terminal 140 may be electrically connected to the second electrode tab 115 of the electrode assembly 110 through the case 120. The second electrode tab 115 may be disposed between the second terminal 140 and the top surface of the electrode assembly 110.

The secondary battery 100 may further include a stopper 150 provided on the top surface of the case 120. The case 120 may further include an electrolyte injection port provided on the top surface between the first terminal 130 and the second terminal 140, and the electrolyte injection port may be sealed by the stopper 150.

However, the present disclosure is not limited thereto, and the case may be configured in various shapes, such as circular and pouch shapes. In some embodiments, the case may be made of a metal such as aluminum, an aluminum alloy, or nickel-plated steel, or a laminated film or plastic that forms the pouch.

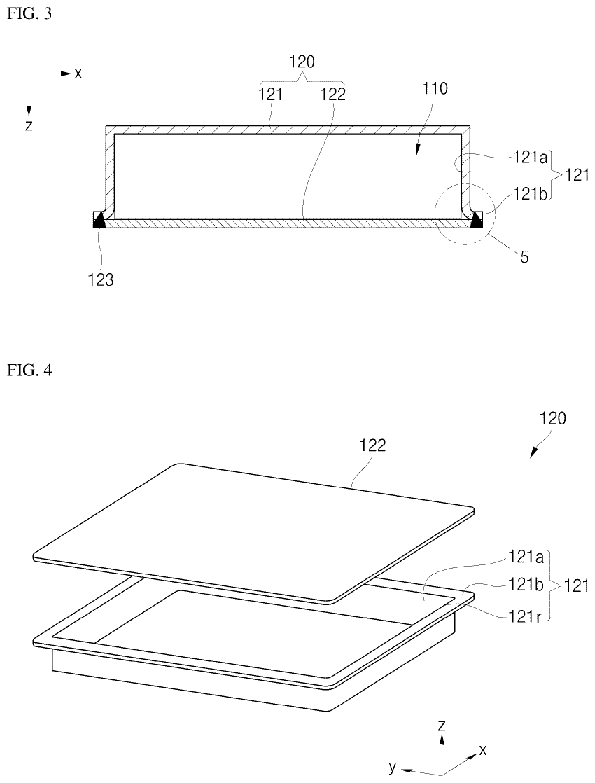

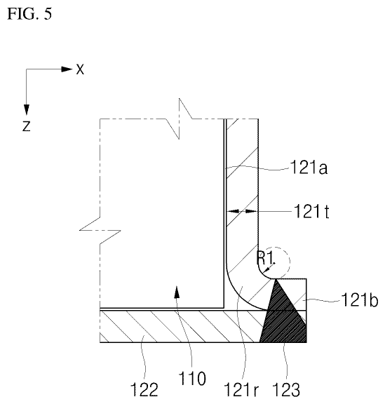

FIG. 3 illustrates a cross-sectional view taken along line 3-3′ of the secondary battery of FIG. 1. FIG. 4 illustrates an exploded perspective view of the case in the secondary battery of FIG. 1. FIG. 5 illustrates an enlarged view of a portion 5 of FIG. 3. Hereinafter, the case 120 in the secondary battery 100 will be described with reference to FIGS. 3 to 5.

The case 120 may include first case 121 that is approximately rectangular in shape and has an opened rear surface, and second case 122 that has a flat plate shape and is coupled to the opened rear surface of the first case 121. The first case 121 may be coupled to the second case 122 by welding in a state of being in contact with the second case 122 after the electrode assembly 110 is accommodated in a recess 121a provided in the first case 121.

The first case 121 may have an approximately rectangular plate shape and may include the recess 121a provided at a center in the first direction x and the second direction y (e.g., a central area). The recess 121a may be a space, in which the electrode assembly 110 is accommodated, and may have a shape corresponding to the shape of the electrode assembly 110. In some embodiments, the recess 121a may be defined to have a size that is large enough to accommodate the electrode assembly 110 through pressing or drawing. For example, the recess 121a may have a rectangular parallelepiped shape with one surface opened.

In some embodiments, an extension part 121b may extend to be bent outward from each of four sides of one end of the recess 121a. The extension part 121b may be integrated and have an approximately rectangular ring shape. In some embodiments, one end of the recess 121a may be disposed on the one opened surface. In some embodiments, an outward direction may be the first direction x and the second direction y parallel to the second case 122. The extension part 121b may be a surface parallel to and coupled to the second case 122. The second case 122 may be coupled by welding in a state in which an edge area thereof is in contact with the extension part 121b of the first case 121. Hereinafter, the area on which the extension part 121b of the first case 121 and the edge of the second case 122 are coupled to each other by the welding will be referred to as a coupling part 123.

In some embodiments, the coupling part 123 may be an area on or through which the first case 121 and the second case 122 are coupled to each other such as by laser welding. For example, the coupling part 123 may be an area coupled by the laser welding as close as possible to the recess 121a in a direction of the extension part 121b of the first case 121 from an outer surface of the second case 122. The first case 121 and the second case 122 may be sealed in a state in which the electrode assembly 110 is accommodated therein by the coupling part 123. The first and second case may be sealed by the coupling part. The coupling part 123 may be disposed on a boundary between the innermost side of the extension part 121b of the first case 121 and a round part 121r. The round part may be between the recess and extension part. For example, the coupling part 123 may be disposed at the innermost side of the extension part 121b and the outermost side of the round part 121r. In the first case 121 and the second case 122, the edge area may be removed except for only a minimum area on which the coupling part 123 ensures sealability, to prevent the size of the case 120 from unnecessarily increasing. In some embodiments, a partial area of the extension part 121b of the first case 121 disposed outside the coupling part 123 and a partial area of the second case 122 may be removed.

In some embodiments, the first case 121 may further include a round part 121r having a certain curvature (e.g., radius of curvature) between the recess 121a and the extension part 121b. The coupling part 123 may be disposed adjacent to the round part 121r. In some embodiments, the curvature radius R1 of the round part 121r may be equal to or greater than a thickness 121t of the first case 121. For example, the curvature radius R1 of the round part 121r may be approximately 100% to approximately 500% of the thickness 121t of the first case 121. In some embodiments, if the curvature radius R of the round part 121r exceeds approximately 500%, the size of the case 120 may unnecessarily increase due to an increase in distance between the coupling part 123 and the recess 121a. As the curvature radius R1 of the round part 121r becomes smaller, the unnecessary area or volume of the case 120 may be reduced with respect to the same capacity, and thus, energy density of the secondary battery 100 may increase. However, if the curvature radius R1 of the round part 121r is less than approximately 100%, the coupling part 123 may be disposed to be adjacent to the recess 121a, and thus, thermal energy due to the laser welding may affect the electrode assembly 110 accommodated inside the recess 121a.

Here, the thickness 121t of the first case 121 is illustrated as a thickness of a sidewall that defines the recess 121a in the drawing, but may also be the thickness of the extension part 121b. In some embodiments, the thickness of the second case 122 may be the same as the thickness of the first case 121. Each of the first case 121 and the second case 122 may have a thickness of approximately 0.05 millimeters (mm) to approximately 0.4 mm. For example, if the thickness 121t of the first case 121 is approximately 0.1 mm, the curvature radius R1 of the round part 121r may be approximately 0.1 mm to approximately 0.5 mm.

Each of the first case 121 and the second case 122 may be made of steel, stainless steel (SUS), nickel-plated steel, or a steel alloy. In some embodiments, the first case 121 and the second case 122 may be made of the same material.

As described above, according to the present disclosure, the secondary battery capable of increasing in energy density by reducing the unnecessary space in the case 120 and the method for manufacturing the same may be provided.

The method may include welding a first case having a recess, in which an electrode assembly is accommodated, and an extension part extending to be bent outward from one end of the recess to a second case having a plate shape parallel to the first case to provide a coupling part through which the first case and the second case are coupled to each other by welding; and removing an area, except for a first area on which the coupling part secures sealability of the first case and the second case, on the extension part of the first case and an edge area of the second case.

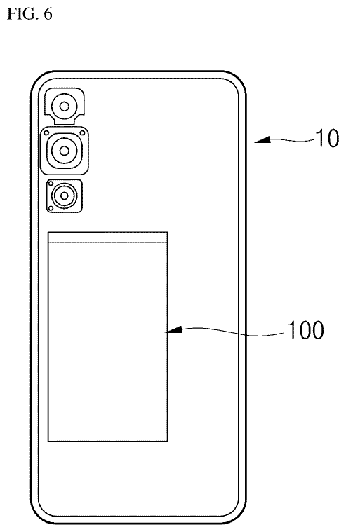

FIG. 6 illustrates a schematic view of a smartphone on which the secondary battery of FIG. 5 is mounted according to some embodiments.

As illustrated in FIG. 6, the secondary battery 100 according to embodiments may be a small battery mounted on a small electronic device such as a smartphone 10. In some embodiments, the smartphone 10 may be an example, and the secondary battery 100 may be applicable to various small electronic devices. The secondary battery 100 according to embodiments may have a structure that increases in capacity of the secondary battery 100 with respect to the same size by reducing the unnecessary space in the case 120 (e.g., removing unnecessary case parts outside the case, thereby securing additional space) and may be suitable for application to the small devices.

The secondary battery according to the above-described embodiments can be used to manufacture a battery pack.

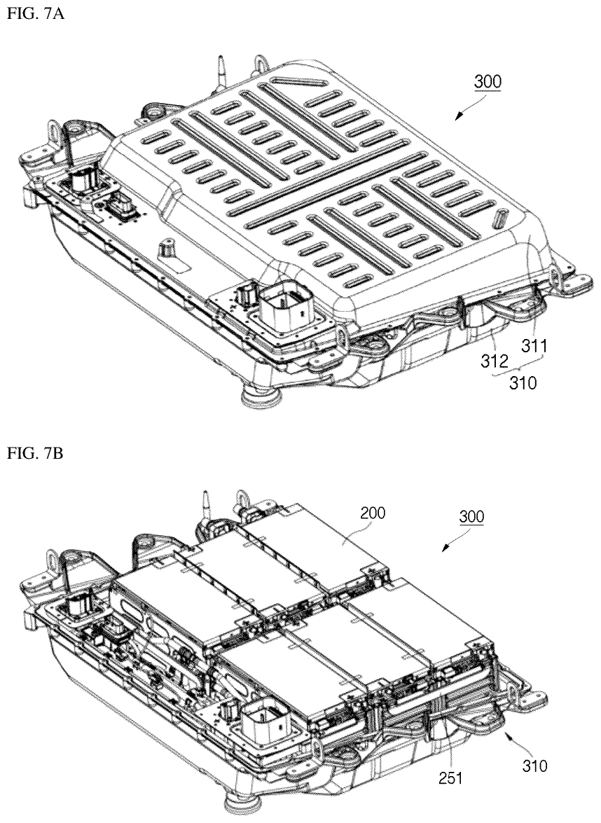

FIGS. 7A and 7B are perspective views showing an exemplary battery pack 300. The battery pack 300 may include a plurality of battery modules 200 and a housing 310 configured to accommodate the plurality of battery modules 200. For example, the housing 310 may include a battery pack cover 311 and a pack frame 312, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

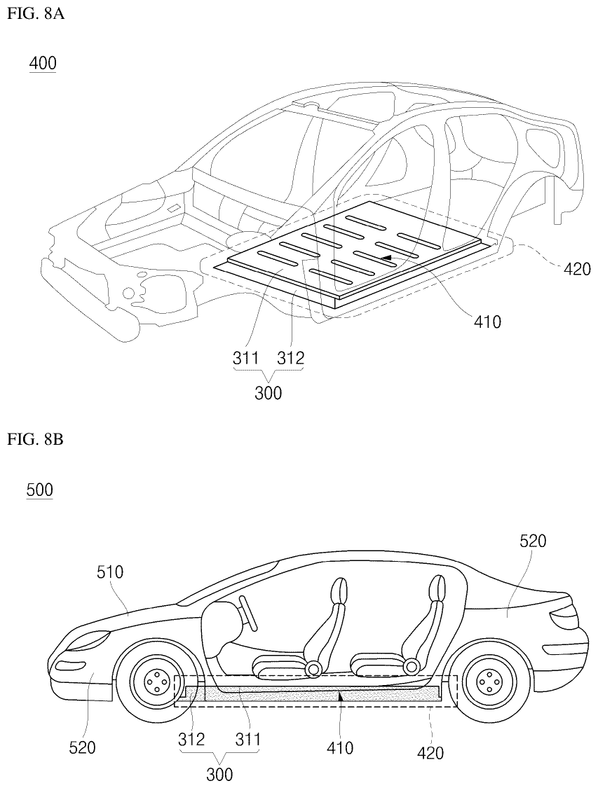

FIGS. 8A and 8B are, respectively, a perspective view showing an exemplary vehicle body 400 and a side view showing an exemplary vehicle 500. As shown in FIG. 8A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 8B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

According to some embodiments, the secondary battery, in which the unnecessary space in the case may be reduced to increase in energy density, and the method for manufacturing the same may be provided.

According to another aspect of the present technology, a battery pack manufactured using a battery with an improved structure and a vehicle including the same can be provided.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

According to another aspect of the present technology, a battery pack manufactured using a battery with an improved structure and a vehicle including the same can be provided.

However, the aspects and features of the present disclosure are not limited to those described above, and other aspects and features not expressly described herein will be clearly understood by a person skilled in the art from the description of example embodiments.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly provided with a first electrode plate and a second electrode plate; and
a case in which the electrode assembly is accommodated,
wherein the case comprises:
a first case having a recess, in which the electrode assembly is accommodated, at a central area thereof, wherein the first case has one opened surface; and
a second case configured to seal the one opened surface of the first case,
wherein the first case further comprises:
an extension part extending from one end of the recess and coupled to the second case; and
a round part between the recess and the extension part,
wherein a curvature radius of the round part is equal to or greater than a thickness of the first case.

2. The secondary battery as claimed in claim 1, wherein the curvature radius of the round part is approximately 100% to approximately 500% of the thickness of the first case.

3. The secondary battery as claimed in claim 1, wherein the second case is a flat plate.

4. The secondary battery as claimed in claim 3, wherein the extension part is parallel to the second case.

5. The secondary battery as claimed in claim 1, wherein the case further comprises a coupling part coupling, by welding, the extension part of the first case to an edge of the second case.

6. The secondary battery as claimed in claim 5, wherein the coupling part is provided by laser welding in a direction of the extension part of the first case from an outer surface of the second case and is adjacent to the recess.

7. The secondary battery as claimed in claim 5, wherein the first case and the second case are sealed by the coupling part.

8. The secondary battery as claimed in claim 5, wherein the coupling part is disposed at a boundary between the extension part of the first case and the round part.

9. The secondary battery as claimed in claim 1, wherein each of the first case and the second case is made of steel, stainless steel, nickel-plated steel, or a steel alloy.

10. The secondary battery as claimed in claim 1, wherein the recess has a rectangular parallelepiped shape with one surface opened, and wherein the extension part is bent to have a round part from four sides of one end of the recess so as to extend in a first direction parallel to the second case and a second direction.

11. The secondary battery as claimed in claim 1, wherein each of the first case and the second case has a thickness of approximately 0.05 mm to approximately 0.4 mm.

12. A method for manufacturing a secondary battery, the method comprising:
welding a first case having a recess, in which an electrode assembly is accommodated, and an extension part extending to be bent outward from one end of the recess to a second case having a plate shape parallel to the first case to provide a coupling part through which the first case and the second case are coupled to each other by welding; and
removing an area, except for a first area on which the coupling part secures sealability of the first case and the second case, on the extension part of the first case and an edge area of the second case.

13. The method as claimed in claim 12, wherein the recess has a rectangular parallelepiped shape with one opened surface, and
the extension part is bent to have a round part from four sides of one end of the recess so as to extend in a first direction parallel to the second case and a second direction,
wherein a curvature radius of the round part is equal to or greater than a thickness of the first case.

14. The method as claimed in claim 13, wherein the curvature radius of the round part is approximately 100% to approximately 500% of the thickness of the first case.
